(19) United States
(12) Patent Application Publication
(10) Pub. No.: US 2023/0074703 A1
(43) Pub. Date: Mar. 9, 2023

(54) COMMUNICATION DELAY MEASUREMENT DEVICE, COMMUNICATION DELAY MEASUREMENT METHOD, AND PROGRAM

(71) Applicant: Nippon Telegraph and Telephone Corporation, Tokyo (JP)

(72) Inventors: Takayoshi Hirasawa, Musashino-shi, Tokyo (JP); Hiroki Mori, Musashino-shi, Tokyo (JP); Satoshi NAKATSUKASA, Musashino-shi, Tokyo (JP); Ken TAKAHASHI, Musashino-shi, Tokyo (JP)

(21) Appl. No.: 17/800,124

(22) PCT Filed: Feb. 21, 2020
(86) PCT No.: PCT/JP2020/007258

§ 371 Date: Aug. 16, 2022

(51) Int. Cl. H04B 10/07; H04L 41/12

(52) U.S. Cl. CPC H04B 10/07; H04L 41/12

(57) ABSTRACT

A communication latency measurement apparatus (10) includes a packet generation unit (12) that generates an SRT packet (packet) to be transmitted to an NW 30 to which a plurality of routers (1r to 6r) by recording path information including an ID of a router serving as a round-trip transfer destination of the packet, a time keeping unit (13) that keeps a time, a transmission/reception unit (11) that records a time kept when the packet is transmitted and/or received as a timestamp for each of transmission and reception in the generated packet, a latency calculation unit 14 that calculates a latency time on a round-trip path from a difference between the transmission and reception timestamps recorded in the received packet and store the latency time in a DB 15 in association with the path information, and a specific segment latency calculation unit 17 that calculates a latency time in a specific router segment from a difference between the stored latency time information of a round-trip path (arrow Y2) including a specific router segment (for example, the segment between routers r1 and r2) and latency time information of another round-trip path (arrow Y3).

### TECHNICAL FIELD

The present invention relates to a communication latency measurement apparatus, a communication latency measurement method, and a program for measuring a latency time on a communication path on a communication network.

### BACKGROUND ART

In recent years, applications for connection to communication networks (NWs), such as the Internet of Things (IoT) or automated driving technologies, have diversified. For this reason, there is an increasing demand on NWs, such as multiple terminal connections, broadband, a low latency, and the like. In particular, 5th generation (5G) NWs are intended to have a bandwidth 100 times that of current networks, and an amount of latency of 1 ms between a communication terminal and a radio base station and about several milliseconds in a case of end-to-end communication, and to be a high capacity network with less fluctuation (jitter) in the amount of latency. It is expected that communication services in the future will be developed with these specifications.

It is assumed that fluctuations particularly caused by traffic congestion, line switching due to failure of a path, and the like occur on a NW. Based on this assumption, a latency of several ms or less in end-to-end communication is a target, so it is important to measure an amount of latency currently provided on NWs.

Examples of existing latency amount measurement techniques include the Internet Control Message Protocol (ICMP) (NPL 1)/Packet Internet Groper (Ping), One-Way/Two-Way Active Measurement Protocol (OWAMP/TWAMP) (NPLs 2, 3, and 4), and the like.

In ICMP/Ping, a transfer apparatus (router) located at one end of one segment on a network to be measured assigns an Internet protocol (IP) address to a transfer apparatus located at the other end and transmits an ICMP echo request message packet thereto. This is a technique in which the apparatus on the reception side sends the packet back to the transmission source apparatus after receiving the packet. The latency time in the round-trip of the packet in the segment that the packet has passed through can be measured if the time taken from the transmission of the packet from the transmission source apparatus until receiving the packet is measured.

In addition, the OWAMP and TWAMP can enable test packets to be exchanged between transfer apparatuses in the same manner as in ICMP/Ping and enable more information such as a loss probability and the median and percentile of an amount of latency to be measured than in Ping.

According to the OWAMP, the transfer apparatuses at both ends of a segment on which measurement is performed are designated as a transmitting apparatus and a receiving apparatus, respectively, and a test packet is transmitted from the transmitting apparatus to the receiving apparatus to measure the performance of the NW in one transmission direction. In addition, according to the TWAMP, the transfer apparatuses at both ends are designated as a transmitting apparatus and a reflecting apparatus that sends a packet back, respectively, and a test packet is exchanged from the transmitting apparatus to the reflecting apparatus and from the reflecting apparatus to the transmitting apparatus to make it possible to measure the performance of the NW in both directions.

### CITATION LIST

### Non Patent Literature

NPL 1: RFC 792, “Internet Control Message Protocol”, [online], [retrieved on Feb. 13, 2020], Internet URL <https://tools.ietf.org/html/rfc792]
NPL 2: RFC 4656, “A One-Way Active Measurement Protocol (OWAMP)”, [online], [retrieved on Feb. 13, 2020], Internet URL <https://tools.ietf.org/html/rfc4656>
NPL 3: RFC 3557, “A Two-Way Active Measurement Protocol (TWAMP)”, [online], [retrieved on Feb. 13, 2020], Internet URL <https://tools.ietf.org/html/rfc5357>
NPL 4: RFC 5905, “Network Time Protocol Version 4”, [online], [retrieved on Feb. 13, 2020], Internet URL <https://tools.ietf.org/html/rfc5905>
NPL 5: Japan Standard Time Group, “Public NTP”, [online], [retrieved on Feb. 13, 2020], Internet URL <http://jjy.nict.go.jp/tsp/PubNtp/qa.html#q2-2]

### SUMMARY OF THE INVENTION

### Technical Problem

However, the above-described latency measurement techniques have three problems as follows.

(1a) It is assumed that, in ICMP/Ping and OWAMP, TWAMP, and the like, two types of apparatuses that are a transmitting apparatus and a receiving apparatus are provided to measure a latency. Thus, two types of apparatuses need to be provided for all the router segments to measure an amount of latency in all of the router segments on the NW, which incurs an increase in equipment costs.
(2a) Timestamps are recorded in packets based on the time kept for each apparatus for the measurement in the ICMP/Ping as well as the OWAMP and TWAMP. For this reason, an accurate latency time cannot be measured if there is a deviation in the times kept for the apparatuses. The Network Time Protocol (NTP) has become the mainstream in the current techniques for time synchronization between apparatuses on an NW. However, the technique for time synchronization using the NTP is a time system dependent on clients, and it has been confirmed that a deviation of up to 800 us from the actual time can appear (NPL 5). For this reason, it is likely that the latency time in a transfer will not be able to be accurately measured due to the deviation in time between the plurality of apparatuses.

(3a) The techniques described in (1a) and (2a) above are based on the assumption of a transfer of a latency measurement packet using an IP transfer. However, the packets are transferred based on a routing protocol for exchanging an IP path on the NW. Thus, when a router segment that is a physical transfer path is to be specified, it is difficult to specify a specific router segment located in the middle of the transfer path.

The present invention has been made in view of the above described circumstances, and an object is to accurately measure a latency in a specific router segment on a communication network at low equipment costs.

### Means for Solving the Problem

To solve the above-described problems, a communication latency measurement apparatus according to the present invention includes: a generation unit that generates a packet to be transmitted to a communication network formed by a plurality of routers network-connected to one another by recording path information including an identifier (ID) of a router serving as a round-trip transfer destination of the packet, a time keeping unit that keeps a time, a transmission/reception unit that transmits and/or receives the packet to and/or from the communication network and records the time kept when the packet is transmitted as a transmission timestamp and the time kept when the packet is received as a reception timestamp in the packet generated by the generation unit, a latency calculation unit that calculates a latency time on a round-trip path from a difference between the transmission timestamp and the reception timestamp recorded in the packet and stores information of the calculated latency time in a database (DB) in association with the path information related to the latency time information, and a specific segment latency calculation unit that calculates a latency time on a round-trip path in a specific router segment specified in advance from a difference between latency time information of a round-trip path including the specific router segment and latency time information of a round-trip path set by excluding the specific router segment from the aforementioned round-trip path, the latency time information being stored in the DB.

### Effects of the Invention

According to the present invention, a latency in a specific router segment on a communication network can be accurately measured at low equipment costs.

### BRIEF DESCRIPTION OF DRAWINGS

FIG. 1 is a block diagram illustrating a configuration of a system including a communication latency measurement apparatus according to an embodiment of the present invention.

FIG. 2 is a block diagram for describing a communication latency measurement operation of the communication latency measurement apparatus according to the present embodiment.

FIG. 3 is a diagram of a hardware configuration illustrating an exemplary computer that realizes the functions of the communication latency measurement apparatus.

FIG. 4 is a flowchart for describing the communication latency measurement operation of the communication latency measurement apparatus according to the present embodiment.

FIG. 5 is a block diagram illustrating a configuration of a system including a communication latency measurement apparatus according to a first application example of the embodiment of the present invention.

FIG. 6 is a block diagram illustrating a configuration of a system including a communication latency measurement apparatus according to a second application example of the embodiment of the present invention.

### DESCRIPTION OF EMBODIMENTS

Hereinafter, embodiments of the present invention will be described with reference to the drawings. However, constituent components having corresponding functions are given the same reference signs in all drawings of the present specification and description thereof will be omitted as appropriate.

### Configuration of Embodiment

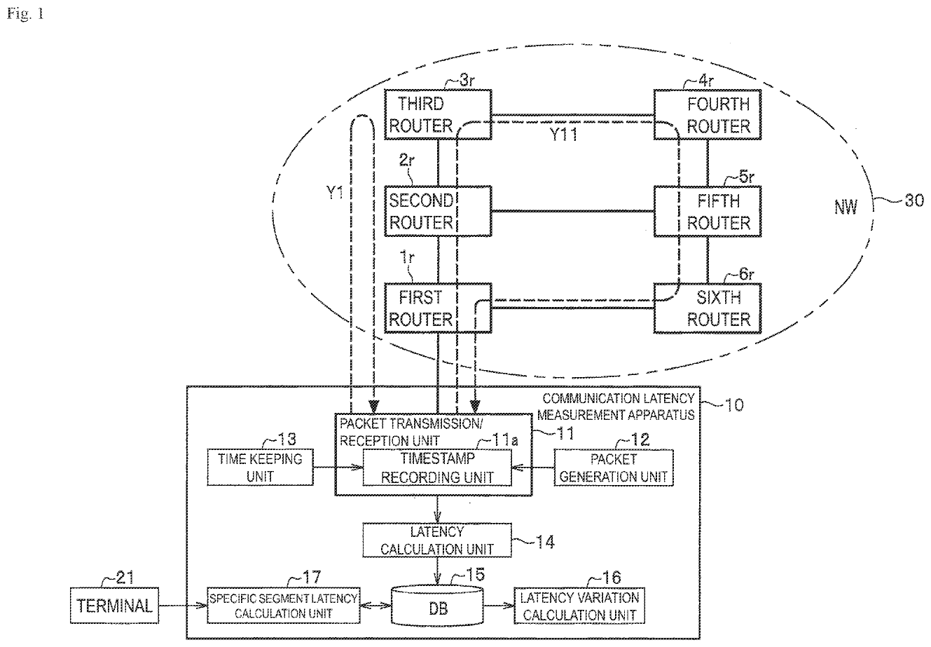

FIG. 1 is a block diagram illustrating a configuration of a system including a communication latency measurement apparatus according to an embodiment of the present invention.
The communication latency measurement apparatus 10 illustrated in FIG. 1 is connected to a communication network (NW) 30 on which latency measurement is to be performed, and includes a packet transmission/reception unit 11 having a timestamp recording unit 11a, a packet generation unit 12, a time keeping unit 13, a latency calculation unit 14, a database (DB) 15, a latency variation calculation unit 16, and a specific segment latency calculation unit 17. A terminal 21 such as an external personal computer is connected to the specific segment latency calculation unit 17. Although the units 11 to 17 of the communication latency measurement apparatus 10 are depicted as being disposed in one apparatus in the present example, these units may also be disposed separately. Further, the communication latency measurement apparatus 10 is also referred to as a measurement apparatus 10.

The NW 30 includes a first router 1r, a second router 2r, a third router 3r, a fourth router 4r, a fifth router 5r, and a sixth router 6r, each serving as a packet transfer apparatus. Among these constituent components, the first router 1r is connected to the second router 2r and the sixth router 6r, and the second router 2r is connected to the third router 3r and the fifth router 5r. Further, the third router 3r is connected to the fourth router 4r, the fourth router 4r is connected to the fifth router 5r, and the fifth router 5r is connected to the sixth router 6r. These connections are made on a transmission line such as an optical fiber.

The packet generation unit 12 generates a symmetric round-trip (SRT) packet or an asymmetric round-trip (ART) packet and outputs the packets to the timestamp recording unit 11a.

An SRT packet is transferred from the measurement apparatus 10 to a specific router (for example, the third router 3r) as indicated by the arrow Y1, and returns to the measurement apparatus 10 through the incoming path in the opposite direction to that of the outgoing path. The SRT packet has a record of identifiers (IDs) of the routers 1r to 6r on the round-trip path as path information in the transfer order from the router on the start point side to the router at the turnaround point. Each of the routers 1r to 6r transfers the SRT packet to the next router while reading the IDs in the transfer order. However, the ID of the measurement apparatus 10 at the final point is recorded as path information for the transfer destination next after the ID of the router at the end point.

An ART packet circulates through each of the routers 1r to 6r one way from the communication latency measurement apparatus 10 and returns to the measurement apparatus 10 as indicated by the arrow Y11. The ART packet has a record of the IDs of the routers 1r to 6r on the circulation path as path information in order of the transfer in the circulation. Each of the routers 1r to 6r transfers the ART packet to the next router while reading the IDs in the transfer order. However, the ID of the measurement apparatus 10 at the final point is recorded as path information for the transfer destination next after the ID of the router at the end point.

Such SRT packets and ART packets are transferred by specifying a path using an NW protocol that can explicitly specify a path, such as segment routing which will be described below. Although the technique of segment routing is used as an example in the present embodiment, the technique is not limited to segment routing as long as a path can be specified. Further, segment routing is a technique in which an NW is represented using an element called a segment identifier and packets are transferred by specifying such a segment. Further, the SRT packets and the ART packets are also referred to simply as packets.

The time keeping unit 13 has a time keeping function to perform a time keeping operation and outputs time keeping information to the timestamp recording unit (also referred to as a recording unit) 11a.

The packet transmission/reception unit (also referred to as a transmission/reception unit) 11 transmits the SRT packet or the ART packet to the first node 1n of the NW 30 and receives the packet returning from the NW 30.

The timestamp recording unit (also referred to as a recording unit) 11a records time information coming from the time keeping unit 13 in the SRT packet or the ART packet as a transmission timestamp when the transmission/reception unit 11 transmits the packet. Furthermore, when the transmission/reception unit 11 receives an SRT packet or an ART packet returning from the NW 30, time information from the time keeping unit 13 is recorded in the packet as a reception timestamp.

The latency calculation unit 14 calculates a latency time from the difference between the transmission timestamp and the reception timestamp recorded in the packet, and stores the latency time information in the DB 15 in association with the path information of the path that the packet has passed through. The latency time information includes latency time information of the round-trip path between the measurement apparatus 10 and a predetermined router, and latency time information of the circulation path on which the packet circulates from the measurement apparatus 10 through the plurality of routers and returns to the measurement apparatus 10. Further, the latency time information and the path information stored in the DB 15 are also referred to as stored information.

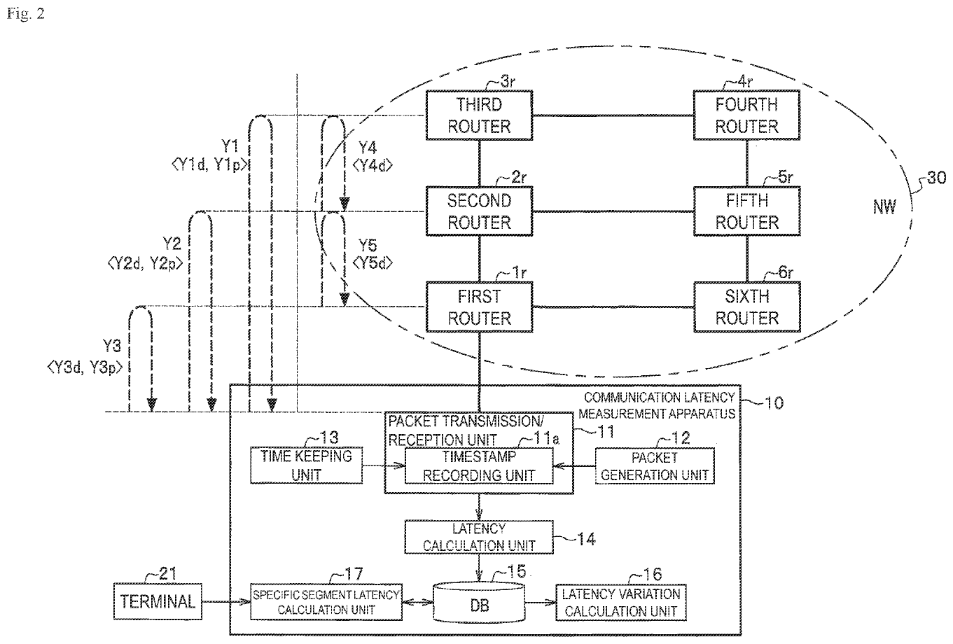

The specific segment latency calculation unit 17 calculates a latency time on a round-trip path in a specific router segment specified in advance (the segment between the routers 1r and 2r) from the difference between the latency time information of a round-trip path (the path indicated by the arrow Y2 in FIG. 2) including the specific router segment (for example, the segment between the routers 1r and 2r) and the latency time information of a round-trip path (the path indicated by the arrow Y3) that is set by excluding the corresponding specific router segment (the segment between the routers 1r and 2r) from the round-trip path (the arrow Y2 in FIG. 2), the latency time information being stored in the DB 15.

It is assumed that, for example, the DB 15 stores latency time information Y1d of the round-trip path from the measurement apparatus 10 to the third router 3r indicated by the arrow Y1 in FIG. 2, latency time information Y2d of the round-trip path from the measurement apparatus 10 to the second router 2r, and latency time information Y3d of the round-trip path from the measurement apparatus 10 to the first router 1r.

In this case, when the specific segment latency calculation unit 17 calculates the difference between the latency time information Y1d and the latency time information Y2d, latency time information Y4d for the round-trip in the segment between the second router 2r and the third router 3r is obtained as a specific segment indicated by the arrow Y4. In addition, when the difference between the latency time information Y2d and the latency time information Y1d is calculated, latency time information Y5d for the round-trip in the segment between the first router 1r and the second router 2r is obtained as a specific segment indicated by the arrow Y5.

A latency time in this specific router segment may be determined such that the specific segment latency calculation unit 17 calculates latency times for all specific segments on the NW 30 or the latency time in a predetermined specific segment. In addition, when a user specifies his or her desired specific segment using the terminal 21, the specific segment latency calculation unit 17 may calculate the latency time in the specified specific segment.

The latency variation calculation unit 16 calculates, for a path segment between the measurement apparatus 10 and a router and a path segment between routers, a variation in the latency time in measurement of this time from the difference between the latency time information measured the previous time and the latency time information measured this time for the same path segment. In other words, whether there is an increase or decrease or whether there is no variation in the latency time measured this time is calculated.

Hardware Configuration

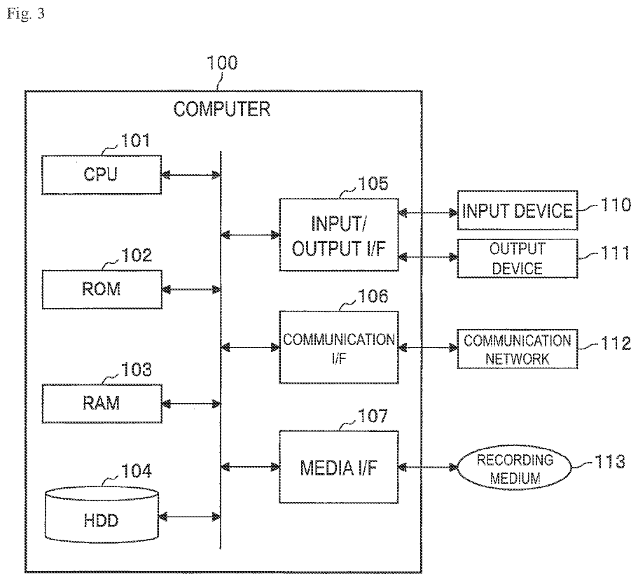

The above-described communication latency measurement apparatus 10 is realized by a computer 100 configured as illustrated in FIG. 3, for example. The computer 100 includes a central processing unit (CPU) 101, a read only memory (ROM) 102, a random access memory (RAM) 103, a hard disk drive (HDD) 104, an input-output interface (I/F) 105, a communication I/F 106, and a media I/F 107.

The CPU 101 operates in accordance with a program stored in the ROM 102 or the HDD 104, and controls each of the functional units. The ROM 102 stores a boot program that is executed by the CPU 101 when the computer 100 is activated, a program for the hardware of the computer 100, and the like.

The CPU 101 controls, via the input/output I/F 105, an output device 111 such as a printer or a display, and an input device 110 such as a mouse or a keyboard. The CPU 101 acquires data from the input device 110 or outputs generated data to the output device 111 via the input/output I/F 105.

The HDD 104 stores a program executed by the CPU 101, data used by the program, and the like. The communication I/F 106 receives data from another apparatus, which is not illustrated, via a communication network 112 and outputs the received data to the CPU 101, and transmits data generated by the CPU 101 to another apparatus via the communication network 112.

The media I/F 107 reads a program or data stored in a recording medium 113 and outputs the program or the data to the CPU 101 through the RAM 103. The CPU 101 loads a program for an intended process from the recording medium 113 in the RAM 103 via the media I/F 107 and executes the loaded program. The recording medium 113 is an optical recording medium such as a digital versatile disc (DVD) and a phase change rewritable disk (PD), a magneto-optical recording medium such as a magneto optical disk (MO), a magnetic recording medium, a conductor memory tape medium, a semiconductor memory, or the like.

For example, when the computer 100 functions as the communication latency measurement apparatus 10 according to the present embodiment, the CPU 101 of the computer 100 realizes the functions of the communication latency measurement apparatus 10 by executing the program loaded on the RAM 103. In addition, the data in the RAM 103 is stored in the HDD 104. The CPU 101 reads a program for an intended process from the recording medium 113 to execute the program. Furthermore, the CPU 101 may read a program for an intended process from another apparatus via the communication network 112.

### Operation of Embodiment

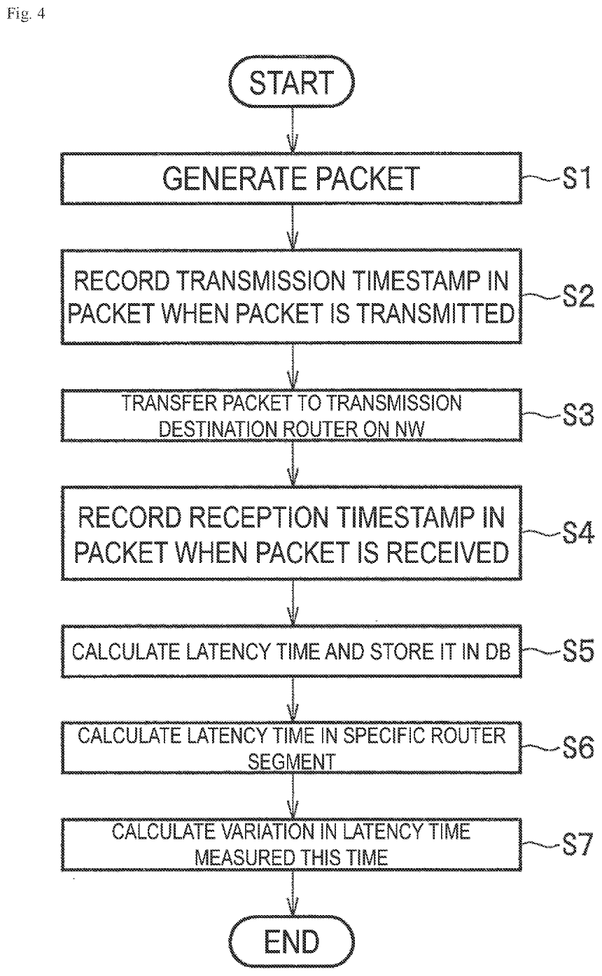

Next, a communication latency measurement operation using the communication latency measurement apparatus 10 according to the embodiment will be described with reference to the flowchart of FIG. 4.
In step S1 illustrated in FIG. 4, it is assumed that the packet generation unit 12 illustrated in FIG. 2 has generated SRT packets as follows. In other words, it is assumed that the packet generation unit 12 has sequentially generated an SRT packet Y1p in which the IDs of the routers 1r, 2r, and 3r are recorded, an SRT packet Y2p in which the IDs of the routers 1r and 2r are recorded, and an SRT packet Y3p in which the ID of the router 1r is recorded, and output the packets to the recording unit 11a.
In step S2, when the transmission/reception unit 11 transmits the packets, the recording unit 11a records time information from the time keeping unit 13 in the packets as transmission timestamps. The transmission timestamps are recorded in each of the SRT packets Y1p to Y3p that have been sequentially transmitted. However, the ID of the measurement apparatus 10 is recorded as path information in each of the SRT packets Y1p to Y3p.

In step S3, the SRT packets Y1p to Y3p after the recording are transferred sequentially to the routers 1r to 3r that are transmission destinations on the NW 30, turned around at the routers 1r to 3r serving as the turnaround points, and then return to the transmission/reception unit 11. In other words, the SRT packet Y1p is transferred sequentially to the routers 1r, 2r, and 3r, turned around at the router 3r, and then returns to the transmission/reception unit 11 via the routers 2r and 1r as indicated by the arrow Y1. The SRT packet Y2p is transferred sequentially to the routers 1r and 2r, turned around at the router 2r, and then returns to the transmission/reception unit 11 via the router 1r, as indicated by the arrow Y2. The SRT packet Y3p is transferred to the router 1r, turned around at the router 1r, and returns to the transmission/reception unit 11, as indicated by the arrow Y3.

In step S4, when the packets that have returned from the NW 30 are received by the transmission/reception unit 11, the recording unit 11a records, as the reception timestamp, time information coming from the time keeping unit 13 in the SRT packets Y1p to Y3p in order of the reception. The SRT packets Y1p to Y3p after the recording are output to the latency calculation unit 14.

In step S5, the latency calculation unit 14 calculates the latency time from the difference between the recorded transmission timestamp and the reception timestamp for each of the SRT packets Y1p to Y3p. The latency calculation unit 14 stores information of the calculated latency time in the DB 15 in association with the path information of the path that the corresponding packet has passed through. In this case, the DB 15 stores the latency time information Y1d of the round-trip path from the measurement apparatus 10 to the third router 3r, the latency time information Y2d of the round-trip path from the measurement apparatus 10 to the second router 2r, and the latency time information Y3d of the round-trip path from the measurement apparatus 10 to the first router 1r.

In step S6, the specific segment latency calculation unit 17 calculates the difference between latency time information of the different round-trip paths stored in the DB 15 to obtain the latency time on the path in the specific router segment as follows. However, the user may specify the specific router segment using the terminal 21.

In other words, the specific segment latency calculation unit 17 calculates the difference between the latency time information Y1d and the latency time information Y2d stored in the DB 15 to obtain the latency time information Y4d for the round-trip in the segment between the second router 2r and the third router 3r as a specific segment. Furthermore, the specific segment latency calculation unit 17 calculates the difference between the latency time information Y2d and the latency time information Y3d to obtain latency time information Y5d for the round-trip in the segment between the first router 1r and the second router 2r as a specific segment.

In step S7, the latency variation calculation unit 16 calculates the variation in the latency time in the measurement of this time from the difference between the latency time information measured the previous time and the latency time information measured this time for the same path segment. For example, it is required that the latency time information Y5d of the round-trip in the segment between the first router 1r and the second router 2r has greatly increased in the measurement of this time compared with in the measurement of the previous time.

### Effects of Embodiment

Next, effects of the communication latency measurement apparatus 10 according to the embodiment will be described.
(1b) The communication latency measurement apparatus 10 includes the packet transmission/reception unit 11 having the timestamp recording unit 11a, the packet generation unit (also referred to as a generation unit) 12, the time keeping unit 13, the latency calculation unit 14, and the specific segment latency calculation unit 17.

The generation unit 12 generates an SRT packet to be transmitted to the NW 30 constituted by the plurality of routers 1r to 6r network-connected to one another by recording path information including the IDs of the routers that are round-trip transfer destinations of the packet. The time keeping unit 13 performs time-keeping.

The transmission/reception unit 11 transmits and/or receives the packets to and/or from the NW 30, and records the time kept when the packets are transmitted as a transmission timestamp and the time kept when the packets are received as a reception timestamp in the SRT packets generated by the generation unit 12.

The latency calculation unit 14 calculates the latency time on the round-trip path from the difference between the transmission timestamp and the reception timestamp recorded in the SRT packet, and stores the calculated latency time information in the DB 15 in association with the path information related to the latency time information.

The specific segment latency calculation unit 17 uses the difference between the latency time information of the round-trip path (the path indicated by the arrow Y2) including the specific router segment (for example, the segment between the routers 1r and 2r) specified in advance and the latency time information of the round-trip path (the path indicated by the arrow Y3) that is set by excluding the corresponding specific router segment from the round-trip path, the latency time information being stored in the DB 15, to calculate the latency time on the round-trip path in the specific router segment (the segment between the routers 1r and 2r).

According to this configuration, the transmission timestamps are recorded in the packets when the packets are transmitted to the NW 30, and the reception timestamps are recorded in the packets when the packets are received. Because the transmission and/or reception timestamps are based on the same times kept by the time keeping unit, it is possible to accurately measure the latency time in the packet transfers. Because there is no need to dispose transmission/reception apparatuses at all router segments on the NW 30 to measure latency in all the router segments, unlike in the related art, only a single communication latency measurement apparatus is required, which reduces equipment costs. In addition, the latency time on a round-trip path in a specific router segment (for example, the segment between the routers 1r and 2r) can be readily calculated by taking the difference in latency times of different round-trip paths. Thus, the latency in the specific router segment on the NW 30 can be accurately measured at low equipment costs.

(2b) The specific segment latency calculation unit 17 is configured to calculate a latency time on a round-trip path in a specific router segment in accordance with specification of the terminal 21 connected to the NW.

According to this configuration, if a user specifies a required specific router segment using the terminal 21, the latency time on the round-trip path in the specific router segment can be determined.

(3b) The latency variation calculation unit 16 that calculates a variation in the latency time in the measurement of this time from the difference between the latency time information measured the previous time and the latency time information measured this time for the same path segment, the information being stored in the DB 15, is further provided.

According to this configuration, it is possible to determine an increase or decrease in the latency time for the same path segment.

### First Application Example of Embodiment

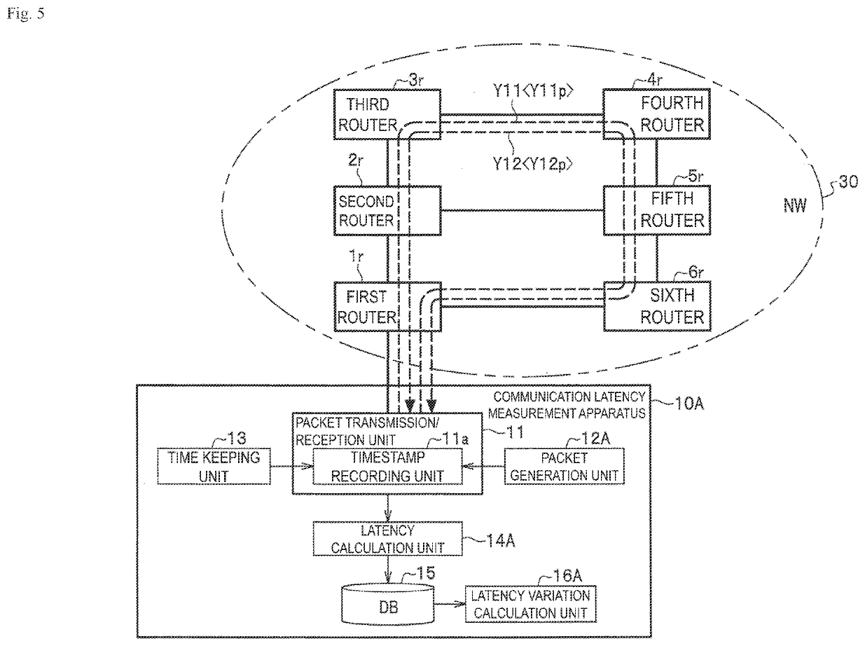

FIG. 5 is a block diagram illustrating a configuration of a system including a communication latency measurement apparatus 10A according to a first application example of the embodiment of the present invention.
The communication latency measurement apparatus 10A of the first application example has a difference from the communication latency measurement apparatus 10 (FIG. 1) in the processing functions of a packet generation unit 12A, a latency calculation unit 14A, and a latency variation calculation unit 16A.

The generation unit 12A generates an ART packet Y11p (described below) transferred to a NW 30 clockwise (in the rightward direction) indicated by the arrow Y11 and an ART packet Y12p (described below) transferred to the NW 30 counterclockwise (in the leftward direction) indicated by the arrow Y12. Further, the ART packet Y11p constitutes the rightward packet described in the claims. The ART packet Y12p constitutes the leftward packet described in the claim.

In the present example, the IDs of the routers 1r to 6r and 1r on the rightward path are recorded as path information in the ART packet Y11p in the rightward transfer order. Each of the routers 1r to 6r and 1r transfers the ART packet Y11p to the next router while reading the IDs in the transfer order. However, the ID of the measurement apparatus 10 at the final point is recorded as path information for the transfer destination next after the ID of the router at the end point.

The IDs of the routers 1r to 6r and 1r on the leftward path are recorded as path information in the ART packet Y12p in the leftward transfer order. Each of the routers 1r to 6r and 1r transfers the ART packet Y12p to the next router while reading the IDs in the transfer order. However, the ID of the measurement apparatus 10 at the final point is recorded as path information for the transfer destination next after the ID of the router at the end point.

The ART packets Y11p and Y12p transmitted in opposite directions to each other are transmitted continuously from the transmission/reception unit 11.

The latency calculation unit 14A calculates the difference between the transmission timestamp and the reception timestamp for the ART packets Y11p and Y12p, and stores the latency time information of the packets in the DB 15 in association with the path information of the path that the packets have passed through as a pair. Because this pair of the pieces of latency time information indicates the latency time of the ART packets Y11p and Y12p transmitted on the same circulation path in the opposite directions, it is generally the same (or substantially the same) latency time information.

The latency variation calculation unit 16A calculates the difference between the pair of the pieces of latency time information to determine the path in the circulation direction with the greater latency time when the difference is equal to or greater than a predetermined value. If a latency such as a queuing delay occurs on one circulation path, the latency time on the one circulation path is greater than the other. Thus, the latency variation calculation unit 16A can determine the circulation path on which the latency time has increased by the predetermined value or greater among the circulation paths in both directions. It is possible to infer that a latency such as a queuing delay has occurred on the determined circulation path.

In addition, the latency variation calculation unit 16A may calculate the variation in the latency time in the measurement of this time from the difference between the latency time information measured the previous time and the latency time information measured this time for a circulation path in the same direction. In this case, whether there is an increase or decrease or whether there is no variation in the latency time on the circulation path in the same direction can be determined.

### Second Application Example of Embodiment

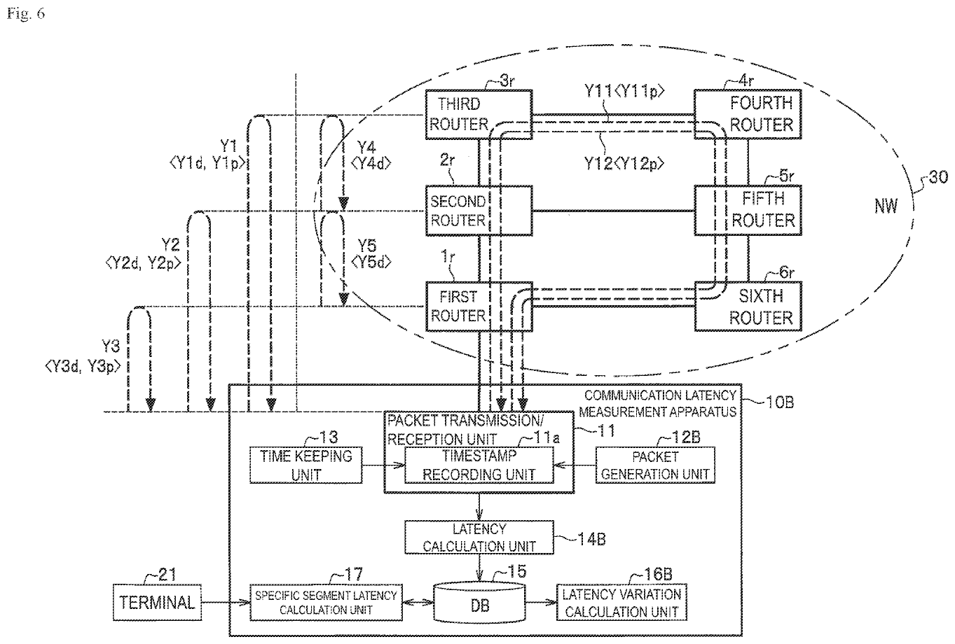

FIG. 6 is a block diagram illustrating a configuration of a communication latency measurement apparatus 10B according to a second application example of the embodiment of the present invention.
The communication latency measurement apparatus 10B of the second application example has a difference from the above-described communication latency measurement apparatus 10A (FIG. 5) in the processing functions of a packet generation unit 12B, a latency calculation unit 14B, and a latency variation calculation unit 16B.

The generation unit 12B generates SRT packets Y1p, Y2p, and Y3p (described below) transferred on the above-described round-trip paths and ART packets Y11p and Y12p transferred on a circulation path in the leftward and rightward directions. Further, although the reference signs of the SRT packets Y1p, Y2p, and Y3p are not illustrated, the arrows Y1, Y2, and Y3 will be referred to for the packets.

The latency calculation unit 14B calculates latency times from the differences between the transmission timestamps and the reception timestamps recorded in the SRT packets Y1p to Y3p, and stores the latency time information in the DB 15 in association with the path information of the paths that the packets have passed through.

In addition, the latency calculation unit 14B calculates the differences between the transmission timestamps and the reception timestamps for the ART packets Y11p and Y12p, and stores the latency time information of the packets in the DB 15 in association with the path information of the path that the packets have passed through as a pair.

The latency variation calculation unit 16B uses both the latency time information for the SRT packets Y1p to Y3p transmitting on the round-trip path and the latency time information for the ART packets Y11p and Y12p transmitting on the leftward and rightward circulation paths, the latency time information being stored in the DB 15, to determine whether a latency has increased in a certain direction among the rightward direction (the direction from the router 1r to the router 2r) or the leftward direction (the direction from the router 2r to the router 1r) in the specific router segment (for example, a segment between router 1r and router 2r).

For example, it is assumed that the latency time in each of eight segments between the transmission/reception unit 11 serving as the end/start point and each of the routers 1r to 6r in the leftward and rightward circulation directions is “10” before a latency occurs, and the latency time in the segment between the specific routers 2r and 1r in the leftward direction after the occurrence of the latency is “100”.

In this case, the latency time in a round-trip between the routers 1r and 2r due to the time difference between the SRT packets Y2p and Y3p that has made the round-trip is “10+10=20” before the occurrence of the latency and is “10+100=110” after the occurrence of the latency.

On the other hand, the latency time of the ART packets Y11p and Y12p on the circulation path in the leftward and rightward directions is “80” in the loop of the eight segments in the leftward and rightward directions before a latency occurs. The latency time of the ART packet Y12p in the leftward direction after the occurrence of the latency is “170” for the following reason. That is, although the latency time of the packet on the loop of the eight segments in the leftward direction before the occurrence of the latency is “10×8 segment=80”, the latency time of the packet in the one segment between the routers 2r and 1r in the leftward direction after the occurrence of the latency is “100” and thus “70+100=170”.

Thus, the amount of latency increase on the circulation path in the leftward direction is “170-80=90”, and thus it can be ascertained from the amount of latency increase “90” that the latency time in the segment between the router 1r and 2r in the leftward direction has increased by “90”. Thus, it can be ascertained that, if the latency time in the segment between the router 1r and 21r is “10” in both the leftward and rightward directions before the occurrence of the latency, the latency time in the segment from the router r2 to the router 1r after the occurrence of the latency is “90+10=100”.

An increase in the latency time in a specific router segment in one direction is determined by the latency variation calculation unit 16 as follows.

First, the latency variation calculation unit 16B calculates the amount of variation in the latency time in the measurement of this time from the difference in the latency time information of the round-trip between the measurement of the previous time and the measurement of this time for the same specific router segment, the latency time information being stored in the DB 15.

If the amount of variation in the latency time is equal to or greater than a predetermined value, the latency variation calculation unit 16B calculates the difference between the pair of the pieces of latency time information for the leftward and rightward circulation paths stored in the DB 15, and specifies the path in the circulation direction on which the latency time is greater from the difference. The latency variation calculation unit 16B determines that the amount of variation in the latency time specified in the previous calculation has increased in the specified specific router segment in the circulation direction.

Although how much the latency time in the specific router segment in one direction has increased is determined in this example, the same can be determined for segments between the transmission/reception unit 11 and the routers 1r to 6r, or a path segment such as a router segment via a router. In this way, it is possible to determine how much the latency time on a certain path segment in any one of the two directions has increased.

Program

Next, a program executed by a computer according to an embodiment will be described. It is assumed that a computer is the communication latency measurement apparatus 10 that measures a latency time on a round-trip path in a router segment on a communication network.

The program causes the computer to function as a section that generates a packet to be transmitted to the NW 30 constituted by the plurality of routers 1r to 6r network-connected to one another by recording path information including IDs of the routers serving as round-trip transfer destinations of the packet, a section that transmits and/or receives the packet to and/or from the NW 30, and records the time kept when the packet is transmitted as a transmission timestamp and the time kept when the packet is received as a reception timestamp in the packet generated by the generation unit 12, a section that calculates a latency time on a round-trip path from the difference between the transmission timestamp and the reception timestamp recorded in the packet and stores the calculated latency time information in the DB 15 in association with path information related to the latency time information, and a section that calculates a latency time on a round-trip path in a specific router segment (the segment between the routers 1r and 2r) from the difference between latency time information for the round-trip path (the path indicated by the arrow Y2) including the specific router segment (for example, the segment between the routers 1r and 2r) specified in advance and latency time information of the round-trip path (the path indicated by the arrow Y3) set by excluding the specific router segment from the aforementioned round-trip path, the latency time information being stored in the DB 15.

With this program, it is possible to obtain effects similar to those of the above-described communication latency measurement apparatus 10.

### Effects

(1) A communication latency measurement apparatus includes a generation unit that generates a packet to be transmitted to a communication network constituted by a plurality of routers network-connected to one another on a network by recording path information including an identifier (ID) of a router serving as a round-trip transfer destination of the packet, a time keeping unit that keeps a time, a transmission/reception unit that transmits and/or receives the packet to and/or from the communication network, and records the time kept when the packet is transmitted as a transmission timestamp and the time kept when the packet is received as a reception timestamp in the packet generated by the generation unit, a latency calculation unit that calculates a latency time on a round-trip path from the difference between the transmission timestamp and the reception timestamp recorded in the packet and stores information of the calculated latency time in a database (DB) in association with the path information related to the calculated latency time information, and a specific segment latency calculation unit that calculates a latency time on a round-trip path in a specific router segment from the difference between latency time information of a round-trip path including the specific router segment specified in advance and latency time information of a round-trip path set by excluding the specific router segment from the aforementioned round-trip path, the latency time information being stored in the DB.

According to this configuration, the transmission timestamp is recorded in the packet when the packet is transmitted to the communication network (NW) and the reception timestamp is recorded in the packet when the packet is received from the NW. Because the transmission and/or reception timestamps are based on the same times kept by the time keeping unit, it is possible to accurately measure the latency time in the packet transfers. Because there is no need to dispose transmission/reception apparatuses at all router segments to measure latency in all the router segments on the NW, unlike in the related art, only a single communication latency measurement apparatus is required, which can reduce equipment costs. In addition, the latency time on a round-trip path in a specific router segment can be easily calculated. Thus, the latency in the specific router segment on the communication network can be accurately measured at low equipment costs.

(2) The communication latency measurement apparatus described in (1) above has the specific segment latency calculation unit configured to calculate a latency time on the round-trip path in the specific router segment in accordance with specification of a terminal connected to the network.

According to this configuration, if a user specifies a desired specific router segment using a terminal, the latency time on the round-trip path in the specific router segment can be determined.

(3) The communication latency measurement apparatus described in (1) or (2) above further has a latency variation calculation unit that calculates a variation in the latency time in the measurement of this time from the difference between latency time information measured the previous time and latency time information measured this time for the same path segment, the latency time information being stored in the DB.

According to this configuration, it is possible to determine an increase or decrease in the latency time for the same path segment.

(4) In the communication latency measurement apparatus described in (3) above, the generation unit generates packets by recording path information including IDs of routers serving as packet circulation transfer destinations in a rightward packet to be transferred in the rightward direction on the same circulation path with the transmission/reception unit as a start/end point on the communication network and in a leftward packet to be transferred in the leftward direction, the latency calculation unit calculates the difference between the transmission timestamp and the reception timestamp for each of the rightward packets and the leftward packets and stores information of the calculated latency time of both packets in the DB in association with path information of paths that the packets have passed through as a pair, and the latency variation calculation unit calculates the difference between the pair of the pieces of latency time information stored in the DB and determines a path in a circulation direction with a greater latency time when the difference is equal to or greater than a predetermined value.

According to this configuration, it is possible to determine a path in a circulation direction in which a latency has increased by the predetermined value or greater. Thus, it is possible to estimate that a latency such as a queuing delay has occurred in the direction of the determined path.

(5) In the communication latency measurement apparatus described in (4) above, the latency variation calculation unit calculates an amount of variation in a latency time in measurement of this time from the difference in latency time information of round-trips measured the previous time and measured this time for the same path segment, the latency time information being stored in the DB, specifies a path in a circulation direction with a greater latency time from the difference between the pair of pieces of latency time information stored in the DB if the amount of variation is equal to or greater than a predetermined value, and determines that the amount of variation in the calculated latency time has increased in the specified same path segment in the circulation direction.

According to this configuration, it is possible to determine how long the latency time in any one direction of both directions of a certain path segment has increased.

(6) A communication latency measurement apparatus includes a generation unit that generates packets to be transmitted to a communication network constituted by a plurality of routers network-connected to one another by recording path information including IDs of routers serving as packet circulation transfer destinations in a rightward packet to be transferred in a rightward direction on the same circulation path on the communication network and in a leftward packet to be transferred in a leftward direction, a time keeping unit that keeps a time, a transmission/reception unit that transmits and/or receives a packet to and/or from the communication network, and records the time kept when the packet is transmitted as a transmission timestamp and the time kept when the packet is received as a reception timestamp in the packet generated by the generation unit, a latency calculation unit that calculates the difference between the transmission timestamp and the reception timestamp for each of the rightward packet and the leftward packet and stores information of the calculated latency time of both packets in a DB in association with path information of paths that the packets have passed through as a pair, and a latency variation calculation unit that calculates the difference between the pair of the pieces of latency time information stored in the DB and determines a path in a circulation direction with a greater latency time when the difference is equal to or greater than a predetermined value.

According to this configuration, it is possible to determine a path in a circulation direction in which a latency has increased by the predetermined value or greater. Thus, it is possible to estimate that a latency such as a queuing delay has occurred in the direction of the determined path.

(7) A communication latency measurement method for a communication latency measurement apparatus that measures a latency time of routers on a communication network constituted by the plurality of routers network-connected to one another, in which the communication latency measurement apparatus performs a step of generating a packet to be transmitted to the communication network by recording path information including an ID of a router serving as a round-trip transfer destination of the packet, a step of keeping a time, a step of transmitting and/or receiving the packet to and/or from the communication network and recording the time kept when the packet is transmitted as a transmission timestamp and the time kept when the packet is received as a reception timestamp in the generated packet, a step of calculating a latency time on a round-trip path from the difference between the transmission timestamp and the reception timestamp recorded in the packet and storing information of the latency time in a DB in association with the path information related to the latency time information, and a step of calculating a latency time on a round-trip path in a specific router segment specified in advance from the difference between latency time information of a round-trip path including the specific router segment and latency time information of a round-trip path set by excluding the specific router segment from the aforementioned round-trip path, the latency time information being stored in the DB.

According to this configuration, the same effects as those of (1) described above can be exhibited.

(8) A program causes a computer to function as the communication latency measurement apparatus described in any one of (1) to (5) described above.

According to this configuration, the same effects as those of (1) to (5) described above can be exhibited.

Furthermore, other appropriate changes can be made to the specific configurations without departing from the spirit of the present invention.

### REFERENCE SIGNS LIST

10, 10A, 10B Communication latency measurement apparatus
11 Packet transmission/reception unit
11a Timestamp recording unit
12, 12A, 12B Packet generation unit
13 Time keeping unit
14, 14A, 14B Latency calculation unit
15 DB
16, 16A, 16B Latency variation calculation unit
17 Specific segment latency calculation unit
21 Terminal
1r to 6r Router

1. A communication latency measurement apparatus, comprising:
a generation unit, including one or more processors, configured to generate a packet to be transmitted to a communication network formed by a plurality of routers network-connected to one another, by recording path information including an identifier (ID) of a router serving as a round-trip transfer destination of the packet;
a time keeping unit, including one or more processors, configured to keep a time;
a transmission/reception unit, including one or more processors, configured to transmit and/or receive the packet to and/or from the communication network, and record the time kept when the packet is transmitted as a transmission timestamp and the time kept when the packet is received as a reception timestamp in the packet generated by the generation unit;
a latency calculation unit, including one or more processors, configured to calculate a latency time on a round-trip path from a difference between the transmission timestamp and the reception timestamp recorded in the packet and store the latency time in a database (DB) in association with the path information related to information of the calculated latency time; and
a specific segment latency calculation unit, including one or more processors, configured to calculate a latency time on a round-trip path in a specific router segment specified in advance from a difference between latency time information of the round-trip path including the specific router segment and latency time information of a round-trip path set by excluding the specific router segment from the round-trip path, the latency time information being stored in the DB.

2. The communication latency measurement apparatus according to claim 1,
wherein the specific segment latency calculation unit is configured to calculate a latency time on the round-trip path in the specific router segment in accordance with specification of a terminal connected to the communication network.

3. The communication latency measurement apparatus according to claim 1 further comprising:
a latency variation calculation unit configured to calculate a variation in a latency time during measuring this time from a difference between latency time information measured a previous time and latency time information measured this time for a same path segment, the latency time information being stored in the DB.

4. The communication latency measurement apparatus according to claim 3,
wherein the generation unit is configured to generate a plurality of packets by recording path information including IDs of a plurality of routers serving as packet circulation transfer destinations in a rightward packet to be transferred in a rightward direction on a same circulation path with the transmission/reception unit as a start/end point on the communication network and in a leftward packet to be transferred in a leftward direction,
the latency calculation unit is configured to calculate a difference between a transmission timestamp and a reception timestamp for each of the rightward packet and the leftward packet and store, as a pair, information of the calculated latency time of both packets in the DB in association with path information of paths that the packets have passed through, and
the latency variation calculation unit is configured to calculate the difference between the pair of pieces of latency time information stored in the DB to determine a path in a circulation direction with a large latency time when the difference is equal to or greater than a predetermined value.

5. The communication latency measurement apparatus according to claim 4,
wherein the latency variation calculation unit is configured to calculate an amount of variation in the latency time in measurement of this time from a difference in latency time information of round-trips measured the previous time and measured this time for a same path segment, the latency time information being stored in the DB, specify a path in a circulation direction with a large latency time from the difference between the pair of pieces of latency time information stored in the DB if the amount of variation is equal to or greater than a predetermined value, and determine that the amount of variation in the calculated latency time has increased in the specified same path segment in the circulation direction.

6. A communication latency measurement apparatus comprising:
a generation unit, including one or more processors, configured to generate a plurality of packets to be transmitted to a communication network formed by a plurality of routers network-connected to one another by recording path information including IDs of routers serving as packet circulation transfer destinations in a rightward packet to be transferred in a rightward direction on a same circulation path on the communication network and in a leftward packet to be transferred in a leftward direction;
a time keeping unit, including one or more processors, configured to keep a time;
a transmission/reception unit, including one or more processors, configured to transmit and/or receive a packet to and/or from the communication network, and record the time kept when the packet is transmitted as a transmission timestamp and the time kept when the packet is received as a reception timestamp in the packet generated by the generation unit;
a latency calculation unit, including one or more processors, configured to calculate a difference between the transmission timestamp and the reception timestamp for each of the rightward packet and the leftward packet and store, as a pair, information of the calculated latency time of both packets in a DB in association with path information of paths that the packets have passed through; and
a latency variation calculation unit, including one or more processors, configured to calculate a difference between the pair of pieces of latency time information stored in the DB and determine a path in a circulation direction with a large latency time when the difference is equal to or greater than a predetermined value.

7. A communication latency measurement method performed by a communication latency measurement apparatus configured to measure a latency time between a plurality of routers on a communication network formed by the plurality of routers network-connected to one another, the method comprising, by the communication latency measurement apparatus;
generating a packet to be transmitted to the communication network by recording path information including an ID of a router serving as a round-trip transfer destination of the packet;
keeping a time;
transmitting and/or receiving the packet to and/or from the communication network, and recording the time kept when the packet is transmitted as a transmission timestamp and the time kept when the packet is received as a reception timestamp in the generated packet;
calculating a latency time on a round-trip path from a difference between the transmission timestamp and the reception timestamp recorded in the packet and storing information of the calculated latency time in association with the path information related to the latency time information in a DB; and
calculating a latency time on a round-trip path in a specific router segment specified in advance from the difference between latency time information of a round-trip path including the specific router segment and latency time information of a round-trip path set by excluding the specific router segment from the round-trip path, the latency time information being stored in the DB.

8. (canceled)

9. The communication latency measurement apparatus according to claim 6,
wherein the generation unit is configured to generate a plurality of packets by recording path information including IDs of a plurality of routers serving as packet circulation transfer destinations in a rightward packet to be transferred in a rightward direction on a same circulation path with the transmission/reception unit as a start/end point on the communication network and in a leftward packet to be transferred in a leftward direction,
the latency calculation unit is configured to calculate a difference between a transmission timestamp and a reception timestamp for each of the rightward packet and the leftward packet and store, as a pair, information of the calculated latency time of both packets in the DB in association with path information of paths that the packets have passed through, and
the latency variation calculation unit is configured to calculate the difference between the pair of the pieces of latency time information stored in the DB to determine a path in a circulation direction with a large latency time when the difference is equal to or greater than a predetermined value.

10. The communication latency measurement apparatus according to claim 9,
wherein the latency variation calculation unit is configured to calculate an amount of variation in the latency time in measurement of this time from a difference in latency time information of round-trips measured a previous time and measured this time for a same path segment, the latency time information being stored in the DB, specify a path in a circulation direction with a large latency time from the difference between the pair of pieces of latency time information stored in the DB if the amount of variation is equal to or greater than a predetermined value, and determine that the amount of variation in the calculated latency time has increased in the specified same path segment in the circulation direction.

11. The communication latency measurement method according to claim 7, further comprising:
calculating a latency time on the round-trip path in the specific router segment in accordance with specification of a terminal connected to the communication network.

12. The communication latency measurement method according to claim 7, further comprising calculating a variation in a latency time during measuring this time from a difference between latency time information measured a previous time and latency time information measured this time for a same path segment, the latency time information being stored in the DB.

13. The communication latency measurement method according to claim 12, further comprising:
generating a plurality of packets by recording path information including IDs of a plurality of routers serving as packet circulation transfer destinations in a rightward packet to be transferred in a rightward direction on a same circulation path as a start/end point on the communication network and in a leftward packet to be transferred in a leftward direction;
calculating a difference between a transmission timestamp and a reception timestamp for each of the rightward packet and the leftward packet;
storing, as a pair, information of the calculated latency time of both packets in the DB in association with path information of paths that the packets have passed through; and
calculating the difference between the pair of pieces of latency time information stored in the DB to determine a path in a circulation direction with a large latency time when the difference is equal to or greater than a predetermined value.

14. The communication latency measurement method according to claim 13, further comprising:
calculating an amount of variation in the latency time in measurement of this time from a difference in latency time information of round-trips measured the previous time and measured this time for a same path segment, the latency time information being stored in the DB;
specifying a path in a circulation direction with a large latency time from the difference between the pair of pieces of latency time information stored in the DB if the amount of variation is equal to or greater than a predetermined value; and
determining that the amount of variation in the calculated latency time has increased in the specified same path segment in the circulation direction.
